(19) United States
(12) Patent Application Publication
(10) Pub. No.: US 2006/0139295 A1
(43) Pub. Date: Jun. 29, 2006

(54) System and method for controlling the operation of a cholesteric display

(75) Inventors: Raymond James Eberhard, Endwell, NY (US); Mark Ronald Hodges, Owego, NY (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/021,503

(22) Filed: Dec. 23, 2004

(51) Int. Cl. G09G 3/36

(52) U.S. Cl. 345/101

(57) ABSTRACT

A cholesteric display includes a display controller and a database. The database includes a control program for programming the operation of the display controller, a display field for storing information to be displayed at the cholesteric display, and a temperature range field for storing the temperature range of the environment of the cholesteric display. An input device is provided for loading control program, display information, and temperature or temperature range data to the database.

### BACKGROUND OF THE INVENTION

1. Technical Field of the Invention

This invention relates to control of cholersteric and other temperature sensitive displays.

2. Background Art

The emergence of Cholesteric Liquid Crystal Displays (ChLCD) provides a revolutionary breakthrough in LCD display technology by providing display technology that consumes no power to maintain an image, while providing a clear, sharp image view, from most viewing angles.

Given their “no power” attribute, ChLCD display technology is well suited for store shelf advertising, electronic price tags, and many other low power display applications where device costs must also be kept to a minimum.

Unlike Super Twisted Nematic LCD displays (STN-LCD displays) and other common display technology, ChLCD displays are updated via more sophisticated methods that define, as is illustrated in FIG. 4, a precise time-voltage relationship that depends on the state and parasitics of a given pixel and the temperature of the ChLCD material. That is, the programming characteristics of a cholesteric display vary with temperature. These characteristics can include the magnitude of voltage and the duration of time the voltage is applied to energize a given pixel. The time-voltage relationship determines the display state of a pixel, that is, how a pixel is charged, and therefor, is displayed.

The time-voltage sequences and the need to adjust these to account for temperature and parasitic effects, increases the physical size and cost of the driver circuitry needed to update a ChLCD display.

The general solution to these variances is to use a temperature sensor to indicate to the display controller to modify the programming characteristics based on temperature. Referring to FIG. 5, a cholesteric display driver 100 includes power supply 108, temperature sensor 110, database 106, display 102 and controller 104. The output of temperature sensor 110 and information to be displayed from, for example, database 106 are fed to display controller 104 which is programmed to control display 102.

Disadvantages of the general solution include the circuit area required on the cholesteric display driver 100 for a temperature sensor 110, the development costs, and for low power applications, the electrical current required. Additionally, voltage requirements unique to temperature sensor 110 impose additional requirements back at the power supply 108.

There is a need in the art for a solution that eliminates the need for a temperature sensor, costs associated with the sensor, including those of development time and power. To reduce the application cost of ChLCD technology a new method is needed to reduce the size and complexity of the circuitry on cholesteric display driver 106, thereby lowering its overall cost.

### SUMMARY OF THE INVENTION

A system, method, and program storage device for controlling a cholesteric display provides for storing display image data and temperature data in a database; providing the image data and temperature data to a display controller; and operating the display controller to convert the image data and temperature data to a voltage-time sequence for driving the cholesteric display.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a high level system diagram illustrating a cholesteric display driver and display in accordance with a preferred embodiment of the invention.

FIG. 2 is a high level system diagram illustrating another embodiment of the invention.

FIG. 3 is a flow chart illustrating the operation of an exemplary embodiment of the invention.

FIG. 4 is a diagram illustrating an exemplary cholesteric display update response time.

FIG. 5 is a high level system diagram illustrating a typical cholesteric display driver and display.

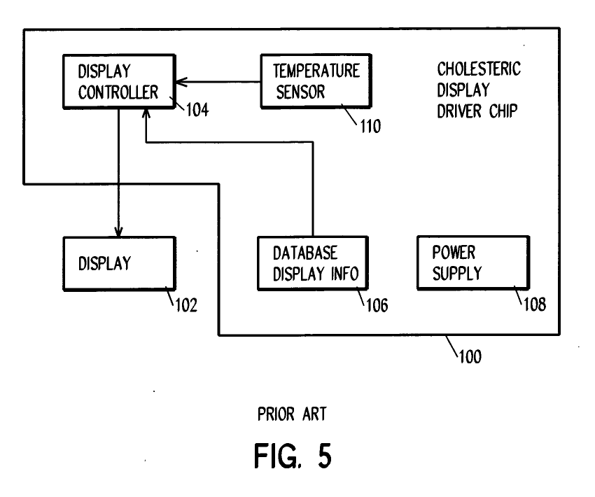

FIG. 6 is a high level system diagram illustrating a program storage device in accordance with the present invention.

### DETAILED DESCRIPTION OF PREFERRED EMBODIMENTS

In accordance with the preferred embodiment of the invention, a cholesteric display is provided with a database of information to be displayed with an entry in the database used to indicate the temperature range of the display's environment. This entry is sent to the display controller to program the display based on a subset of the full operating temperature range of the display.

Further in accordance with the preferred embodiment of the invention, a method is provided for ChLCD display update whereby the need for a temperature sensor integrated with the driver circuitry and/or the display itself is eliminated, especially useful where the display's temperature is within a known range, or can be measured by a remote temperature sensing device. Such a sensing device could also, for example, be shared by multiple displays and other electronic systems.

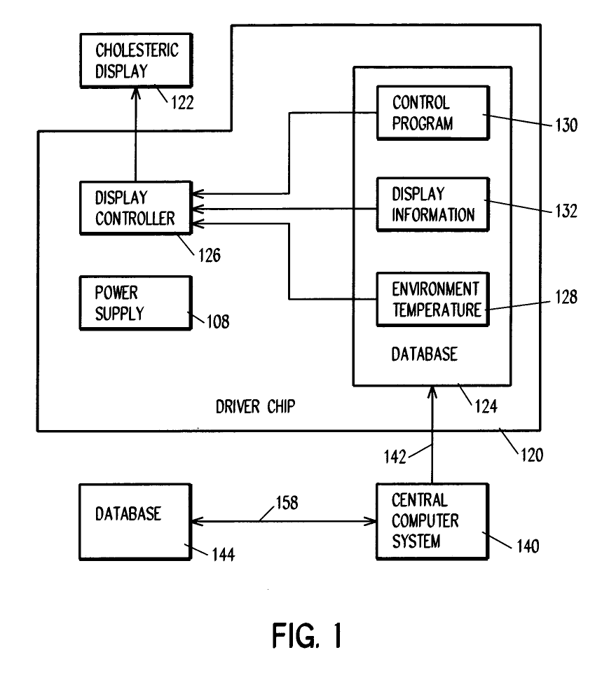

Referring to FIG. 1, a cholesteric display application in accordance with an exemplary embodiment of the invention includes driver 120, a cholesteric display 122, database 124, and central computer system (CCS). Database or storage device 124 includes fields defining information to be displayed 126, control program 130, and environment temperature range 128. Control program 130 controls the programming of display 122, including the operation of display controller 120, and display information 126 defines the information to be displayed at a specific cholesteric display 122. The invention is particularly useful for battery powered 108 devices having cholesteric displays 122. For example, database 144 may include the price of an item to be displayed on cholesteric display 122 and the ambient temperature of the display. When central computer system 140 initiates an update of display 122, the price data, accompanied by temperature data is transferred from database 144 thru central computer system 140 to driver chip 120. At driver chip 120 the pricing data is captured by display information 132 and the display's temperature, as recorded in database 144 is captured by environment temperature 128. Upon receipt of pricing and temperature data, the control program 130 initiates an update of the display 122 by transferring the environment temperature 128 and the display information 132 to display controller 126. Upon receipt of information 132 to display controller 126. Upon receipt of this information by display controller 126, the control program updates display 122 with the pricing information in a manner influenced by the temperature of display 122.

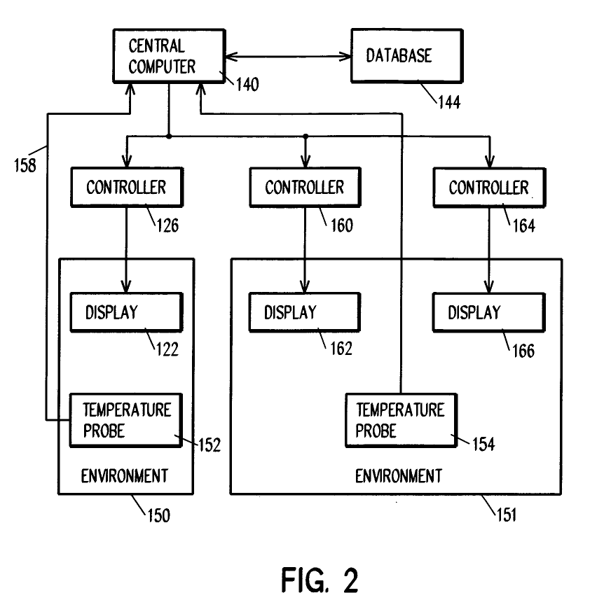

Referring to FIG. 2 in connection with FIG. 1, further in accordance with an exemplary embodiment, a plurality of ChLCD displays 122, 162, 166 are provided, each with a respective controllers 126, 160, 164. Probes 152, 154 are provided for sensing the temperature within the environment 150 of display (ChLCD) 122, and within environment 151 of displays 162, 166.

ChLCD display's driver electronics 120 (likely an ASIC) is communicated as is represented by line 142 via wire or wirelessly from Central Control System (CCS) 140. CCS 140 stores all imagery to be displayed on ChLCD displays 122, 162, 166, and initiates the update of one or more displays, when appropriate, with new imagery to display. Each display 122, 162, 166 is uniquely addressable by CCS 140 with one or more of these displays located in an environment 150 of varied, but known temperature. Temperature is known based on the area 150 in which display 122 resides, i.e. heating/cooling system preset temperature, or can be monitored via a temperature probe 152, 154 that communicates to the CCS the temperature of the monitored area 150, 151.

When CCS 140 determines that a specific, addressable ChLCD display 122 requires update, CCS 140 accesses its database 144 to obtain the image data to be displayed at the given display 122 address, and also queries its database 144 to obtain the temperature of target display 122. The temperature obtained by the CCS 140 may be delivered from a database 144 record pre-assigned to the display address that stores a temperature representing temperature of the environment 150 where display 126 resides, or it may be delivered from a remote temperature sensor 152 monitoring the same area 150 as display 122. A given ChLCD display's database 144 records indicate whether a pre-recorded temperature should be used, stored as a record in the database, or if a temperature probe 152 co-located within the same area as the display should be read and conveyed, as is represented by line 158 to central control system 140.

When CCS 140 has obtained the image and temperature data of the addressed display 122 from database 144, these are communicated to the display driver 120 where, in accordance with an exemplary embodiment, they are stored to database 124, or fed directly to display controller 126 (this path is not shown). Once received by the display's driver circuitry 120 from CCS, the image and temperature data are translated by controller 126 to the necessary voltage-time sequence required to update display 122.

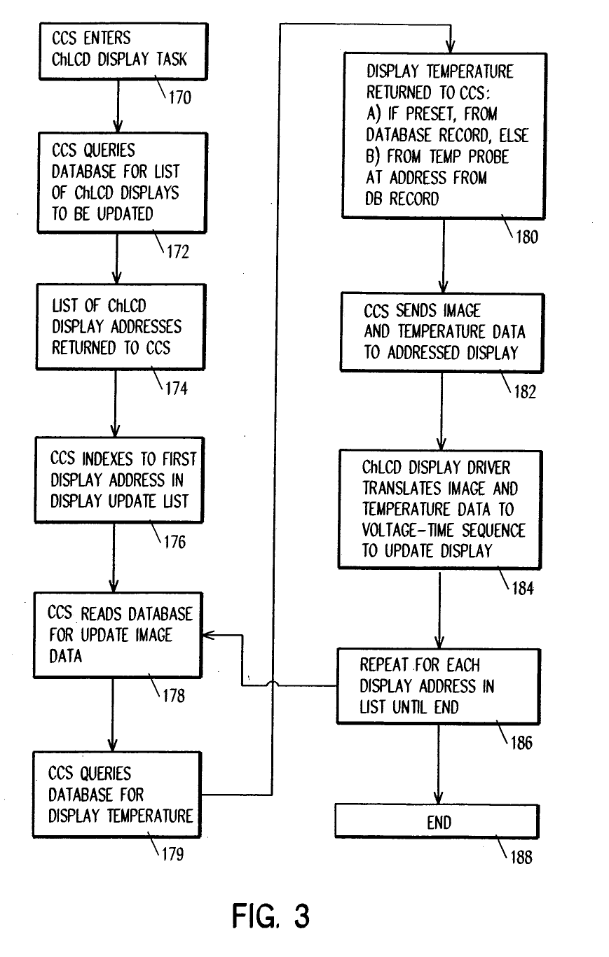

Referring to FIG. 3, a method in accordance with an exemplary embodiment of the invention is set forth.

In step 170, Central Control System (CCS) 140 enters the ChLCD display task.

In step 172, CCS 140 queries database 144 for a list of ChLCD displays 122, 162, 166 to be updated.

In step 174, a list of ChLCD display addresses returned to CCS 140 from database 144.

In step 176, CCS 140 indexes to the first display address in the display update list.

In step 178, using the display address, CCS 140 reads database 144 to obtain the content of image data needed to update the display.

In step 179, CCS 140 queries database 144 for the display temperature.

In step 180, the display temperature is either returned from the database 144 record (if the temperature has been pre-set), or CCS 140 retrieves temperature data from a temperature probe 152 located at the address provided by database 144.

In step 182, CCS 140 conveys temperature and image data to the addressed ChLCD display driver 120 either directly or via database 124 records 128, 132.

In step 184, ChLCD display driver 120 receives image and temperature data and translates this to the voltage-time sequence required to update display 122.

In step 186, CCS 140 increments to next display address in the display list and returns to step 178, or if none exist, in step 188 CCS 140 terminates the ChLCD display task In accordance with a further exemplary embodiment of the invention, for a cholesteric display system that uses a database 144 for information to be displayed, an entry in the database is associated with an individual display 122 and is used to indicate the temperature range of the display's environment 150. This entry is sent to display driver 120 to program display controller 126 on a subset of the full operating temperature range of display 122.

The power savings and resulting battery 108 extension by removing temperature sensor 110 are illustrated by the following example. Consider a cost sensitive, power consumptive sensitive cholesteric display multi-chip system with a typical application of supermarket price tag.

Suppose that the battery specified is a 55 mah lithium/manganese dioxide battery with a ten year shelf life. On an exemplary technology, power measurements on a temperature sensor show the sensor consumes 2.6 ma of current. The chip in which the temperature sensor resides has a current budget of 5.3 ma. The temperature sensor therefore consumes 50% of the total current budget for the chip. Based on the battery specified, the maximum current draw for this system is 6.5 ma, 40% of which is consumed by the temperature sensor. Removing the temperature sensor will give back 2.6 ma of current to the remaining logic of the system.

The cell savings for removing the temperature are as follows. The cell area for the sensor in 0.18 um technology is 0.0905 sq mm. This area includes the diode, A/D converter and digital counters in the temperature sensor design. The target die size for this chip in the display system is 2 sq mm. The temperature sensor constitutes 4.5% of the total chip area. This may not be significant by itself but may save enough space to retain the current die size or even reduce it.

Referring again to FIGS. 1 and 2, in accordance with a further embodiment of the invention, database 144 contains information to be displayed at a given display 122 and control information used to control the programming of the display. For example, the database may include the price of an item to be displayed and the temperature range of area 150 in which display 122 resides. When display 122 is updated, the price of an item is sent to display controller 126 along with the temperature range associated with the display in database 144, either directly or via database 124. This method eliminates the need for display technology such as, but not limited to, cholesteric displays to contain or require display controllers 100 having temperature sensors 110.

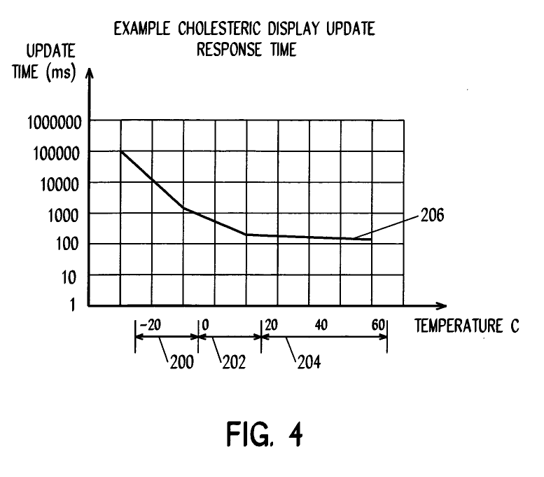

Consider a super market price tag example. The temperature ranges in which the price tags are used can be divided into three categories, including freezer 200, cooler 202, and room temperature and above 204. These three ranges may be superimposed on a cholesteric update response time curve 206 of FIG. 4, with a temperature region for the freezer, another for the cooler, and third for room temperature and above.

In this example, database 144 includes fields for item, price of item, and one of these three temperature categories (or regions). When display 122 is updated, information in database 144 is sent to display controller 126, which translates the temperature range into programming control for display 122 based on one of three categories (or regions), 200, 202, or 204 within which the display resides.

In order to update a display 122 operating in the cooler region 202, assuming the actual temperature is 5 degrees C. and the most favorable display is produced by worst case temperature, database 144 indicates (is preset to show) this item is in the cooler region 202 which is within a range from −2 degrees C. to 18 degrees C. When display 122 is programmed by controller 126, the temperature selected is −2 degrees C. Since the temperature pre-set and selected is colder but within the proper operating range, the display programs correctly.

### ADVANTAGES OVER THE PRIOR ART

It is an advantage of the present invention that here is provided a system and method for controlling a cholesteric display that does not require a display controller with a temperature sensor.

### ALTERNATIVE EMBODIMENTS

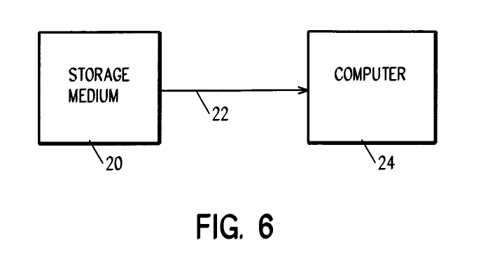

It will be appreciated that, although specific embodiments of the invention have been described herein for purposes of illustration, various modifications may be made without departing from the spirit and scope of the invention. Referring to FIG. 6, in particular, it is within the scope of the invention to provide a computer program product or program element, or a program storage or memory device 20, 22 such as a solid or fluid transmission medium, magnetic or optical wire, tape or disc, or the like, for storing signals readable by a machine 24, for controlling the operation of a computer according to the method of the invention and/or to structure its components in accordance with the system of the invention.

Further, each step of the method may be executed on any general computer, such as IBM Systems designated as zSeries, iSeries, xSeries, and pSeries, or the like and pursuant to one or more, or a part of one or more, program elements, modules or objects generated from any programming language, such as C++, Java, Pl/1, Fortran or the like. And still further, each said step, or a file or object or the like implementing each said step, may be executed by special purpose hardware or a circuit module designed for that purpose.

Accordingly, the scope of protection of this invention is limited only by the following claims and their equivalents.

We claim:

1. A method for controlling a cholesteric display, comprising:
storing display image data and temperature data in a database;
providing said image data and temperature data to a display controller; and
operating said display controller to convert said image data and temperature data to a voltage-time sequence for driving said cholesteric display.

2. The method of claim 1, further comprising:
operating a central computer system with a database including image data and temperature information for a plurality of cholesteric displays;
generating a list of displays for updating; and
for each display in said list, serving to a respective display controller said image data and temperature data.

3. The method of claim 2, said temperature indicia being temperature data preset in said database.

4. The method of claim 2, said temperature indicia being an address to a temperature probe positioned in an environment of said display for providing said temperature data to said central computer system.

5. A system for controlling a cholesteric display, comprising:
a display controller;
a database, said database including a control program for programming the operation of said display controller, a display field for storing display information to be displayed at said cholesteric display, and a temperature range field for storing the temperature range, of the environment of said cholesteric display; and
an input device for loading control program, display information, and temperature range data to said database.

6. The system of claim 5, further comprising:
a central database for storing said display information and temperature indicia; and
a central computer system responsive to said central database for feeding said temperature range data and display information to said display controller.

7. The system of claim 6, further comprising:
a plurality of said cholesteric displays;
said central data base storing said display information and temperature indicia for each of said cholesteric displays; and
said central computer system providing said temperature range data selectively from temperature data preset in said central database or from a temperature probe positioned in the environment of said cholesteric display.

8. A program storage device readable by a machine, tangibly embodying a program of instructions executable by a machine to perform operations for controlling a cholesteric display, said operations comprising:
storing display image data and temperature data in a database;
providing said image data and temperature data to a display controller; and
operating said display controller to convert said image data and temperature data to a voltage-time sequence for driving said cholesteric display.

9. The program storage device of claim 8, said operations further comprising:
operating a central computer system with a database including image data and temperature information for a plurality of cholesteric displays;
generating a list of displays for updating; and
for each display in said list, serving to a respective display controller said image data and temperature data.

10. The program storage device of claim 9, said temperature indicia being temperature data preset in said database.

11. The program storage device of claim 10, said temperature indicia being an address to a temperature probe positioned in an environment of said display for providing said temperature data to said central computer system.
